(19) United States
(12) Patent Application Publication
(10) Pub. No.: US 2025/0305339 A1
(43) Pub. Date: Oct. 2, 2025

(54) VEHICLE DOOR WITH POWER CLOSE FUNCTION HAVING NON-CONTACT OBSTACLE DETECTION AND METHOD

(71) Applicant: MAGNA CLOSURES INC., Newmarket (CA)

(72) Inventor: Ryan HERMAN, Newmarket (CA)

(21) Appl. No.: 19/092,311

(22) Filed: Mar. 27, 2025

Related U.S. Application Data
(60) Provisional application No. 63/570,491, filed on Mar. 27, 2024.

(51) Int. Cl. E05F 15/42

(52) U.S. Cl. CPC E05F 15/42; E05Y 2400/32; E05Y 2900/531

(57) ABSTRACT

A power door system for a door of a vehicle is provided. The system includes an actuator for moving the door. The system also includes a sensor having a field of view for detecting an obstacle between the door and a body of the vehicle. The system further includes a controller connected to the actuator and to the sensor. The controller is adapted to detect the obstacle within the field of view that varies during movement of the door

### CROSS-REFERENCE TO RELATED APPLICATION

This application claims the benefit of U.S. Provisional Application Ser. No. 63/570,491, filed Mar. 27, 2024, which is incorporated herein by way of reference in its entirety.

### FIELD

The present disclosure relates to obstacle detection for a power door. More specifically, the present disclosure relates to a door system using obstacle detection to control a power actuator assembly for a vehicle side door.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. Such swinging passenger doors (“swing doors”) may be moveable by power closure member actuation systems. Specifically, the power closure member system can function to automatically swing the passenger door about its pivot axis between the open and closed positions, to assist the user as he or she moves the passenger door, and/or to automatically move the passenger door in between closed and open positions for the user.

Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Scheuring et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

A high-resolution position sensor, such as a magnet wheel and a Hall effect sensor, may be used to accurately measure a position of the closure member. In addition, various other sensors, such as non-contact obstacle detection (NCOD) sensors may be used to detect obstacles. The power closure member actuation system can use the NCOD sensors, however, operation using the NCOD sensor can be highly complex due to obstacle recognition and variations in possible obstacles that may be encountered.

In view of the above, there remains a need to develop power door or closure member systems and methods of operation which address and overcome limitations and drawbacks associated with known power closure member actuation systems and power actuators as well as to provide increased convenience and enhanced operational capabilities.

### SUMMARY

This section provides a general summary of the disclosure, and is not a comprehensive disclosure of its full scope or all of its features.

It is an object of the present disclosure to provide a power door system for a door of a vehicle. The system includes an actuator for moving the door. The system also includes a sensor having a field of view for detecting an obstacle between the door and a body of the vehicle. The system additionally includes a controller connected to the actuator and to the sensor. The controller is adapted to detect the obstacle within the field of view that varies during movement of the door.

It is another object of the disclosure to provide a method of operating a power door system for a door of a vehicle. The method includes the step of moving the door using an actuator. The method also includes the step of detecting an obstacle between the door and a body of the vehicle using a sensor having a field of view varying during movement of the door.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and a vehicle body, according to aspects of the disclosure;

FIG. 2 is a perspective inner side view of a closure member shown in FIG. 1, with various components removed for clarity purposes only, in relation to a portion of the vehicle body and which is equipped with the power closure member actuation system, according to aspects of the disclosure;

FIG. 3 illustrates a block diagram of the power closure member actuation system, according to aspects of the disclosure;

FIG. 4 illustrates another block diagram of the power closure member actuation system for moving the closure member in an automatic mode, according to aspects of the disclosure;

FIGS. 5 and 5A illustrates the power closure member actuation system shown as part of a vehicle system architecture, according to aspects of the disclosure;

FIG. 6 illustrates another block diagram of the power closure member actuation system for moving the closure member in a powered assist mode, according to aspects of the disclosure;

FIG. 7 is a side view of the vehicle illustrating the angle or position of the doors as the doors are closed, according to aspects of the disclosure;

FIG. 8 is a perspective view of the door of the vehicle open and illustrating a sensor position of the sensor and a known point on the body of the vehicle, according to aspects of the disclosure;

FIG. 8A is a perspective view of the door of the vehicle open and illustrating a sensor position of the sensor and more than one known points on the body of the vehicle, according to aspects of the disclosure;

FIG. 9 is a top view of the vehicle showing the door in an open position and illustrates an obstacle and the protect gap, according to aspects of the disclosure; and

FIGS. 10 and 11 illustrate steps of a method of operating a power door system, according to aspects of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

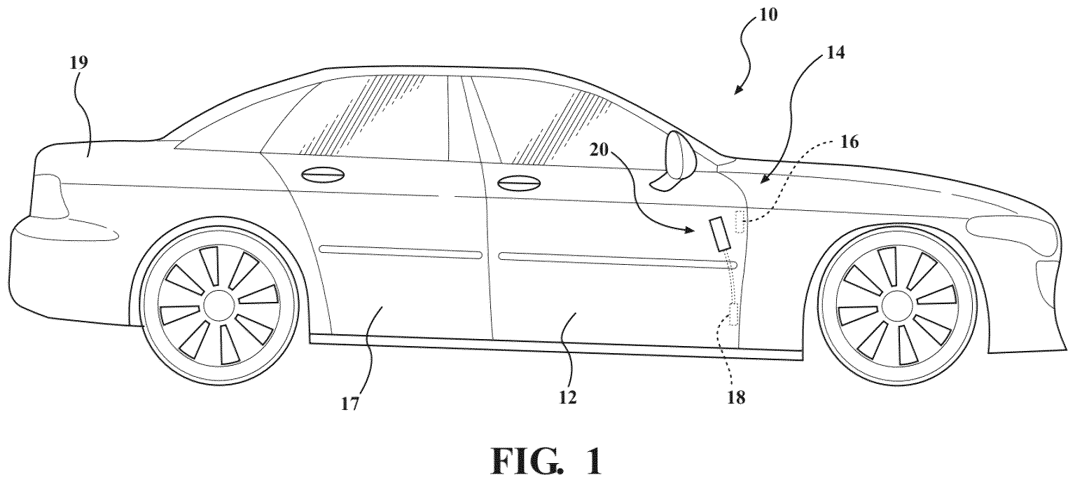

Referring initially to FIG. 1, an example motor vehicle 10 is shown to include a first passenger door 12 pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

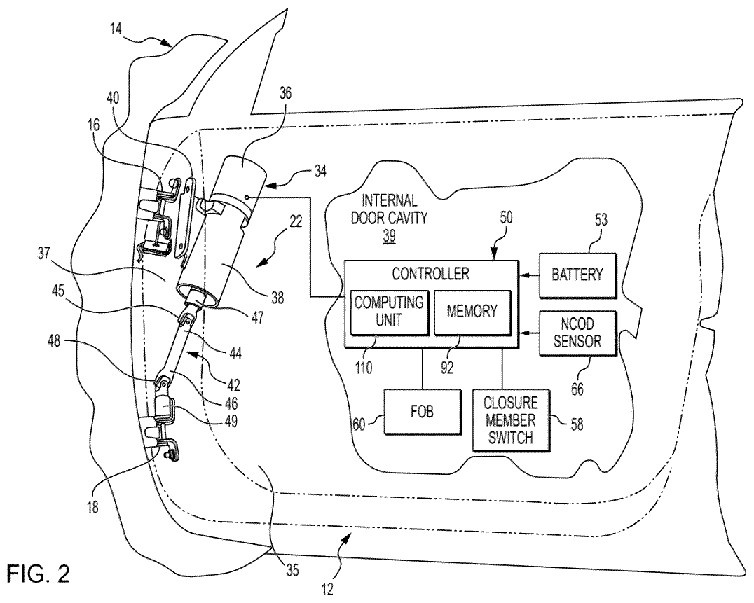

Power closure member actuation system 20 is generally shown in FIG. 2 and, as mentioned, is operable for controllably pivoting vehicle door 12 relative to vehicle body 14 between an open position and a closed position. Lower hinge 18 of power closure member actuation system 20 includes a door hinge strap connected to vehicle door 12 and a body hinge strap connected to vehicle body 14. Door hinge strap and body hinge strap of lower door hinge 18 are interconnected along a generally vertically-aligned pivot axis via a hinge pin to establish the pivotable interconnection between door hinge strap and body hinge strap. However, any other mechanism or device can be used to establish the pivotable interconnection between door hinge strap and body hinge strap without departing from the scope of the subject disclosure.

As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to the door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis of the door 12. The mounting of motor and geartrain assembly 34 adjacent to upper door hinge 16 of vehicle door 12 minimizes the effect that power closure member actuation system 20 may have on a mass moment of inertia (i.e., pivot axis) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e., power-off engagement) and could be selectively energized (i.e., power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-drivable” gearing.

Second end 46 of drive shaft 42 is coupled to body hinge strap of lower door hinge 18 for directly transferring the rotational force from motor and geartrain assembly 34 to door 12 via body hinge strap. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to body hinge strap of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating body hinge strap about its pivot axis to which drive shaft 42 is attached and relative to door hinge strap. As a result, power closure member actuation system 20 is able to effectuate movement of vehicle door 12 between its open and closed positions by “directly” transferring a rotational force directly to body hinge strap of lower door hinge 18. With motor and geartrain assembly 34 connected to vehicle door 12 adjacent to upper door hinge 16, second end 46 of drive shaft 42 is attached to body hinge strap of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to door hinge strap.

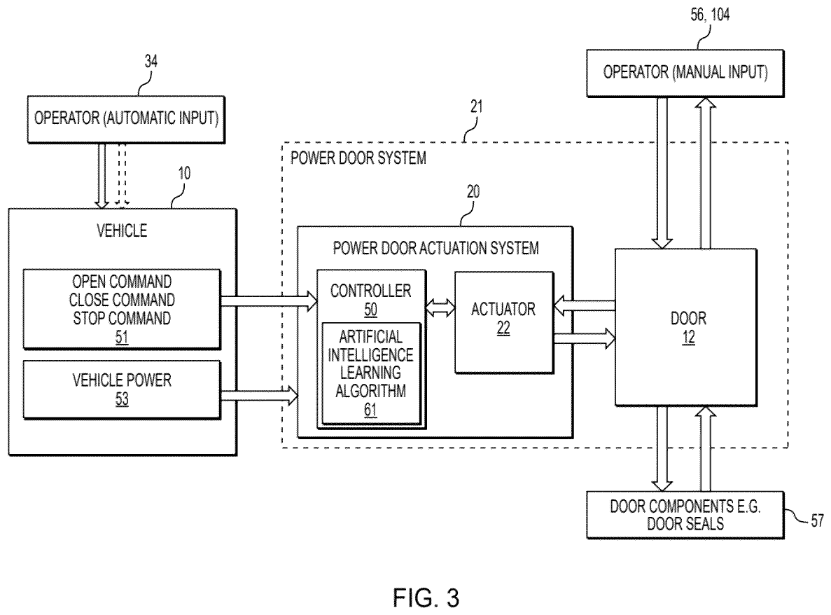

FIG. 3 illustrates a block diagram of the power closure member actuation system 20 of a power door system 21 for moving the closure member (e.g., vehicle door 12) of the vehicle 10 between open and closed positions relative to the vehicle body 14. As discussed above, the power closure member actuation system 20 includes the actuator 22 that is coupled to the closure member (e.g., vehicle door 12) and the vehicle body 14. The actuator 22 is configured to move the closure member 12 relative to the vehicle body 14. The power closure member actuation system 20 also includes an actuator controller 50 that is coupled to the actuator 22 and in communication with other vehicle systems (e.g., a door node control module 52 or a body control module (BCM)) and also receives vehicle power from the vehicle 10 (e.g., from a vehicle battery 53).

The actuator controller 50 is operable in at least one of an automatic mode (in response to an automatic mode initiation input 54) and a powered assist mode (in response to a motion input 56). In the automatic mode, the actuator controller 50 commands movement of the closure member through a predetermined motion profile (e.g., to open the closure member). The powered assist mode is different than the automatic mode in that the motion input 56 from the user 75 may be continuous to move the closure member, as opposed to a singular input by the user 75 in automatic mode. Actuator controller 50 may therefore be configured as a servo controller which may for example receive electrical signals indicative of the position of the door from the closure member actuation system 20, such as a high position count sensor as will be described in more details herein below as an illustrative example, and in response send electrical signals to the actuator 22 based on the received high position count signals to move the door closure member 12. No separate button or switch activations by a user are needed to move the closure member 12, the user only requires to directly move the closure member 12. Commands 51 from the vehicle systems may, for example, include instructions the actuator controller 50 to open the closure member, close the closure member, or stop motion of the closure member. Such control inputs, such as inputs 54, 56 may also include other types of inputs 55, such as an input from a body control module, which may receive a wireless command to control the door opening based on a signal such as a wireless signal received from the key fob 60, or other wireless device such as a cellular smart phone, or from a sensor assembly provided on the vehicle, such as a radar or optical sensor assembly detecting an approach of a user, such as a gesture or gait e.g. walk of the user 75 upon approach of the user 75 to the vehicle. Also shown are other components that may have an impact on the operation of the power closure member actuation system 20, such as door seals 57 of the vehicle door 12, for example. In addition, environmental conditions 59 (rain, cold, heat, etc.) may be monitored by the vehicle 10 (e.g., by the body control module 52) and/or the actuator controller 50. The actuator controller 50 also includes an artificial intelligence learning algorithm 61 (e.g., series of nodes forming a neural network model), discussed in more detail below.

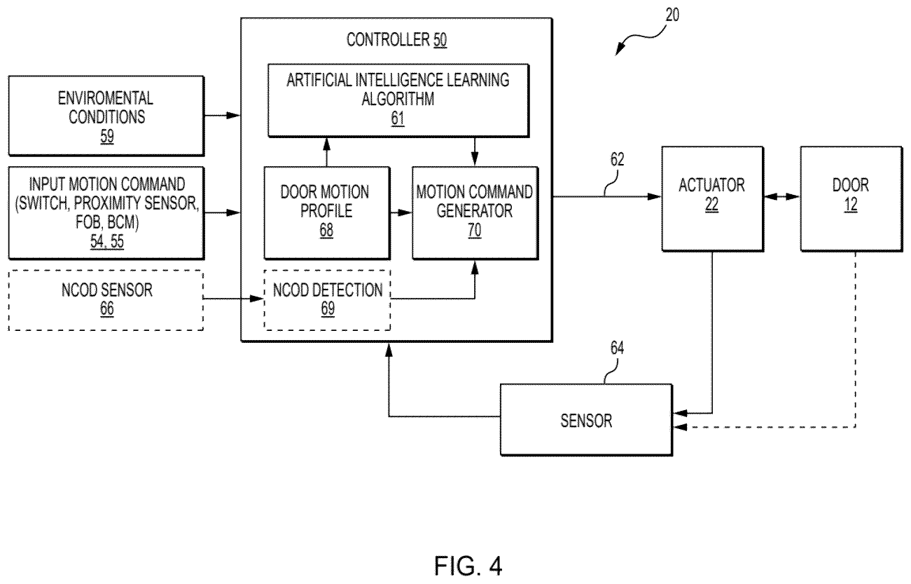

Referring now to FIG. 4, the actuator controller 50 is configured to receive the automatic mode initiation input 54 and enter the automatic mode to output a motion command 62 in response to receiving the automatic mode initiation input 54 or input motion command 62. The automatic mode initiation input 54 can be a manual input on the closure member itself or an indirect input to the vehicle (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10, for example. It should also be appreciated that other automatic mode initiation inputs 54 are contemplated, such as, but not limited to a proximity of the user 75 detected by a proximity sensor.

In addition, the power closure member actuation system 20 includes at least one closure member feedback sensor 64 for determining at least one of a position and a speed and an attitude of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the actuator controller 50. Feedback sensor 64 in communication with actuator controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuity) for detecting movement of a target on the closure member (e.g. on the hinge) or actuator 22 (e.g. on a motor shaft) as examples, and/or may also be software based (e.g. using code and logic for executing a ripple counting algorithm) executed by the actuator controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the actuator controller 50. The actuator controller 50 is configured to determine whether an obstacle is detected using the at least one non-contact obstacle detection sensor 66 (e.g., using a non-contact obstacle detection algorithm 69) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar based sensor 66 or to characterize the object as a user or human as compared to an non-human object for example based on determining the reflectivity of the object using a radar based sensor 66 and system. The non-contact obstacle detection system may also be configured determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

In the automatic mode, the actuator controller 50 can include one or more closure member motion profiles 68 that are utilized by the actuator controller 50 when generating the motion command 62 (e.g., using a motion command generator 70 of the actuator controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and finally stops at an open position) and is continually optimized per user feedback (e.g., automatic mode initiation input 54).

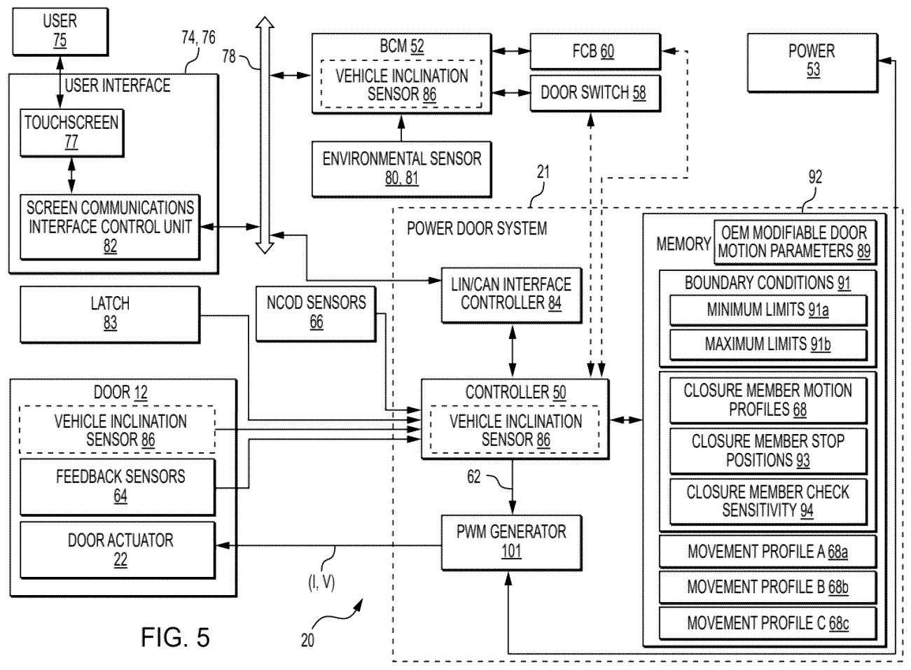

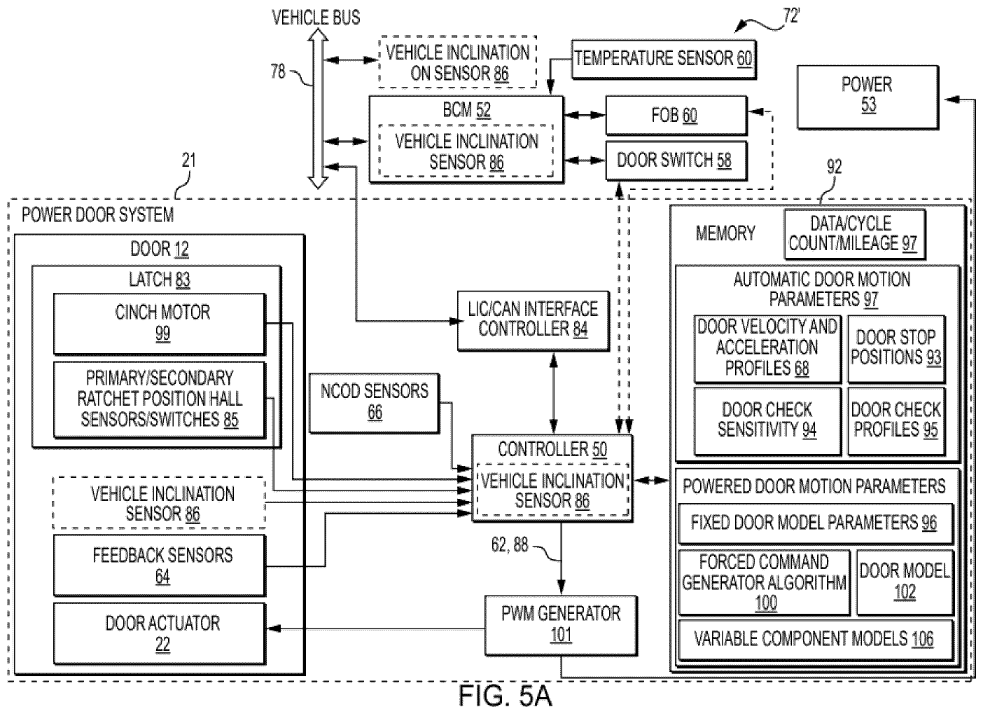

In FIG. 5, the power closure member actuation system 20 is shown as part of a vehicle system architecture 72 corresponding to operation in the automatic mode. The power closure member actuation system 20 includes a user interface 74, 76 that is configured to detect a user interface input from a user 75 via an interface 77 (e.g., touchscreen) to modify at least one stored motion control parameter associated with the movement of the closure member. Thus, the actuator controller 50 of the power closure member actuation system 20 or user modifiable system is configured to present the at least one stored motion control parameter on the user interface 74, 76.

The body control module 52 is in communication with the actuator controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the actuator controller 50 or otherwise communicated to the actuator controller 50. The body control module 52 may also be in communication with an environmental sensor (e.g., temperature sensor 80). The actuator controller 50 is also configured to modify the at least one stored motion control parameter in response to detecting the user interface input. A screen communications interface control unit 82 associated with the user interface 74, 76 can, for example, communicate with a closure communications interface control unit 84 associated with the actuator controller 50 via the vehicle bus 78. In other words, the closure communication interface control unit 84 is coupled to the vehicle bus 78 and to the actuator controller 50 to facilitate communication between the actuator controller 50 and the vehicle bus 78. Thus, the user interface input can be communicated from the user interface 74, 76 to the actuator controller 50.

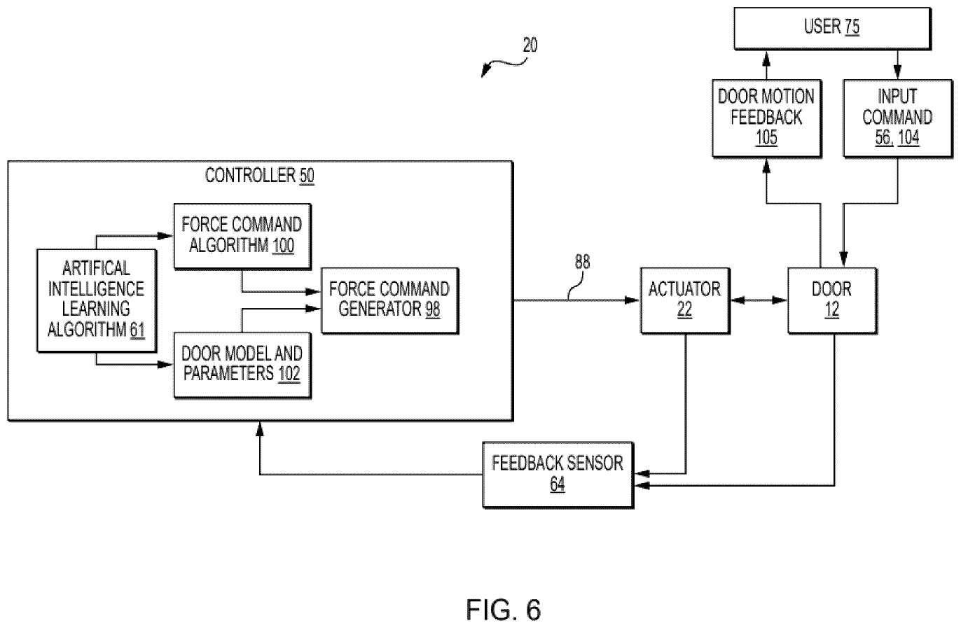

A vehicle inclination sensor 86 (such as an accelerometer) is also coupled to the actuator controller 50 for detecting an inclination of the vehicle 10. The vehicle inclination sensor 86 outputs an inclination signal corresponding to the inclination or tilt of the vehicle 10, for example inclination or tilt relative to the direction of gravity, and the actuator controller 50 is further configured to receive the inclination signal and adjust the one of a force command 88 (FIG. 6) and the motion command 62 accordingly. While the vehicle inclination sensor 86 may be separate from the actuator controller 50, it should be understood that the vehicle inclination sensor 86 may also be integrated in the actuator controller 50 or in another control module, such as, but not limited to the body control module 52.

The actuator controller 50 is further configured to perform at least one of an initial boundary condition check prior to the generation of the command signal (e.g., the force command 88 or the motion command 62) and an in-process boundary check during the generation of the command signal. Such boundary checks prevent movement of the closure member and operation of the actuator 22 outside a plurality of predetermined operating limits or boundary conditions 91 and will be discussed in more detail below.

The actuator controller 50 can also be coupled to a vehicle latch 83. In addition, the actuator controller 50 is coupled to a memory device 92 having at least one memory location for storing at least one stored motion control parameter associated with controlling the movement of the closure member (e.g., door 12). The memory device 92 can also store one or more closure member motion profiles 68 (e.g., movement profile A 68a, movement profile B 68b, movement profile C 68c) and boundary conditions 91 (e.g., the plurality of predetermined operating limits such as minimum limits 91a, and maximum limits 91b). The memory device 92 also stores original equipment manufacturer (OEM) modifiable door motion parameters 89 (e.g., door check profiles and pop-out profiles).

The actuator controller 50 is configured to generate the motion command 62 using the at least one stored motion control parameter to control an actuator output force acting on the closure member to move the closure member. A pulse width modulation unit 101 is coupled to the actuator controller 50 and is configured to receive a pulse width control signal and output an actuator command signal corresponding to the pulse width control signal.

Similar to FIG. 5, FIG. 5A shows the power closure member actuation system 20 as part of another vehicle system architecture 72′ operable in the automatic mode and the powered assist mode. The body control module 52 may also be in communication with at least one environmental sensor 80, 81 for sensing at least one environmental condition 59. Specifically, the at least one environmental sensor 80, 81 can be at least one of a temperature sensor 80 or a rain sensor 81. While the temperature sensor 80 and rain sensor 81 may be connected to the body control module 52, they may alternatively be integrated in the body control module 52 and/or integrated in another unit such as, but not limited to the actuator controller 50. In addition, other environmental sensors 80, 81 are contemplated.

The controller is also coupled with the latch 83 that includes a cinch motor 99 (for cinching the closure member 12 into the closed position). The latch 83 also includes a plurality of primary and secondary ratchet position sensors or switches 85 that provide feedback to the actuator controller 50 regarding whether the latch 83 is in a latch primary position or a latch secondary position, for example. Latch 83 may include a controller or and Electronic Control Unit (ECU), such as exemplary latch configurations described in US20170341526A1, WO2020232543A1, US20200270913A1, US20180245379A1, US20140175813A1, the entireties of which are incorporated by reference herein.

Again, the vehicle inclination sensor 86 (such as an accelerometer or inclinometer) is also coupled to the actuator controller 50 for detecting the inclination of the vehicle 10. The vehicle inclination sensor 86 outputs an inclination signal corresponding to the inclination of the vehicle 10 and the actuator controller 50 is further configured to receive the inclination signal and adjust the one of the force command 88 (FIG. 6) and the motion command 62 accordingly. Accordingly may be for example adjusting the motion command 62 such that door 12 moves at the same speed and motion profile as compared to the door 12 being moved by a motion command as if on a level terrain. As a result, the actuator 22 may move the door 12 such that the motion profile (e.g. speed versus door position) when on an incline is the same as or is tracking to the motion profile as if the vehicle was not on an incline. In other words the user detects no visual difference in the door motion appearance of speed versus position as when the vehicle 10 is on an incline or not. Or for example accordingly may be adjusting the force command 88 such that door 12 is moved applying the similar resistance force detected by a user as compared to the door being moved by a force command as if on level terrain. As a result, the actuator 22 may move the door such that the force required to move the door 12 by a user when on an incline is the same as the force required by a user to move the door as if the vehicle was not on an incline. In other words, the user experiences the same reactionary resistive force of the door acting against the input force of the user when the vehicle 10 is on an incline or not.

A pulse width modulation unit 101 is also coupled to the actuator controller 50 and is configured to receive a pulse width control signal and output an actuator command signal corresponding to the pulse width control signal. The actuator controller 50 includes a processor or other computing unit 110 in communication with the memory device 92. So, the actuator controller 50 is coupled to the memory device 92 for storing a plurality of automatic closure member motion parameters 68, 93, 94, 95 for the automatic mode and a plurality of powered closure member motion parameters 96, 100, 102, 106 for the powered assist mode and used by the actuator controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93, a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

Consequently, the actuator controller 50 is configured to receive one of the motion input 56 associated with the powered assist mode and the automatic mode initiation input 54 associated with the automatic mode. The actuator controller 50 is then configured to send the actuator 22 one of a motion command 62 based on the plurality of automatic closure member motion parameters 68, 93, 94, 95 in the automatic mode and the force command 88 based on the plurality of powered closure member motion parameters 96, 100, 102, 106 in the powered assist mode to vary the actuator output force acting on the closure member 12 to move the closure member 12. The actuator controller 50 additionally monitors and analyzes historical operation of the power closure member actuation system 20 using the artificial intelligence learning algorithm 61 and adjusts the plurality of automatic closure member motion parameters 68, 93, 94, 95 and the plurality of powered closure member motion parameters 96, 100, 102, 106 accordingly.

As discussed above, the power closure member actuation system 20 can include an environmental sensor 80, 81 in communication with the actuator controller 50 and configured to sense at least one environmental condition of the vehicle 10. Thus, the historical operation monitored and analyzed by the actuator controller 50 using the artificial intelligence learning algorithm 61 can include the at least one environmental condition of the vehicle 10. So, the controller is further configured to adjust the plurality of automatic closure member motion parameters 68, 93, 94, 95 and the plurality of powered closure member motion parameters 96, 100, 102, 106 based on the at least one environmental condition of the vehicle 10.

As best shown in FIG. 6, the actuator controller 50 is also configured to receive the motion input 56 and enter the powered assist mode to output the force command 88 (e.g., using a force command generator 98 of the actuator controller 50 as a function of a force command algorithm 100, door model 102, boundary conditions 91, a plurality of closure member component profiles 106 as discussed in more detail below) as modified by the artificial intelligence learning algorithm 61. The actuator controller 50 is also configured to generate the force command 88 to control an actuator output force acting on the closure member to move the closure member. So, the actuator controller 50 varies an actuator output force acting on the closure member to move the closure member in response to receiving the motion input 56. In the powered assist mode, the force command 88 has a specified force profile (e.g., that may be altered to change the user experience with the closure member, such as by making it lighter or heavier, or based on changes in the environmental condition and modified by the artificial intelligence learning algorithm 61, such as by increasing or decreasing the force assist provided to the user 75). The force command 88 is continually optimized per current user feedback, for example. A user movement sensor 104 is coupled to the actuator controller 50 and is configured to sense the motion input 56 from the user 75 on the closure member to move the closure member. Door motion feedback 105 is also provided from the closure member (e.g., door 12) back to the user 75. Again, the power closure member actuation system 20 further includes at least one closure member feedback sensor 64 for determining at least one of a position and speed of the closure member. The at least one closure member feedback sensor 64 detects the position and/or speed of the closure member, as described above for the automatic mode, and can provide corresponding position/motion information or signals to the actuator controller 50 concerning how the user 75 is interacting with the closure member. For example, the at least one closure member feedback sensor 64 determine how fast the user 75 is moving the closure member (e.g., door 12). The attitude or inclination sensor 86 may also determine the angle or inclination of the closure member and the power closure member actuation system 20 may compensate for such an angle to assist the user 75 and negate any effects on the closure member motion that the change in angle causes (e.g., for example changes regarding how gravity may influence the closure member differently based on the angle of the closure member relative to a ground plane). One example of an actuator controller and door motion algorithms and methods are shown and described in WO2020252601A1, entitled “A power closure member actuation system”, also referred to herein as the “'601 PCT Application”, the entire contents of which is incorporated herein by reference. For example, actuator controller 50 may be configured to calculate a compensating force value and control the electric motor 36 to output the compensating force value to control the motion of the door 12 to assist with the input force of a user on the door, or to assist with compensating for door motion resistances, such as do to friction, inclination, momentum, and so forth.

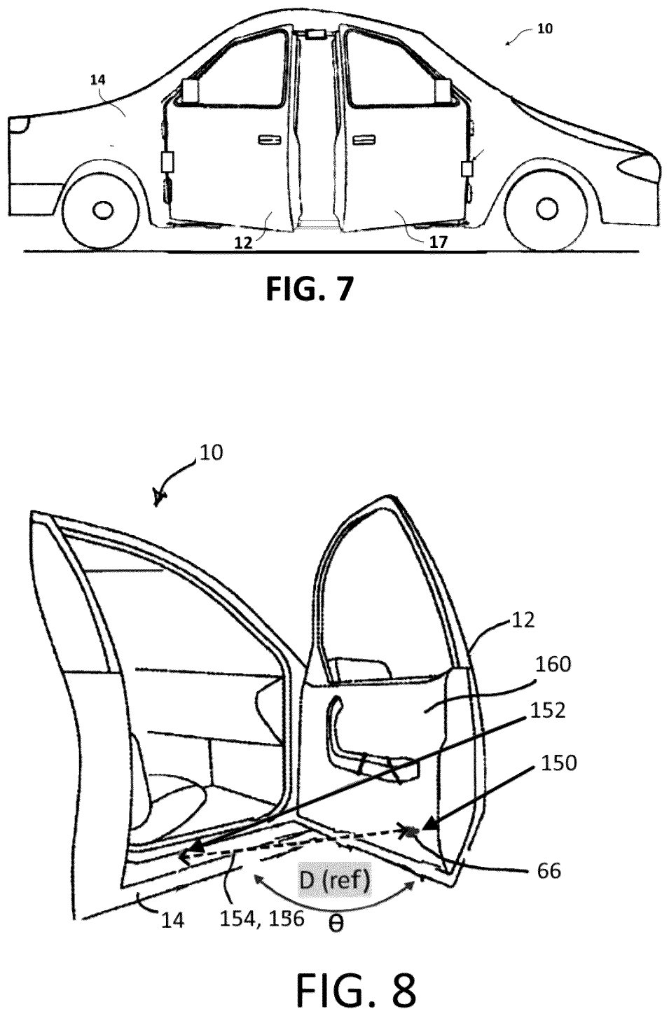

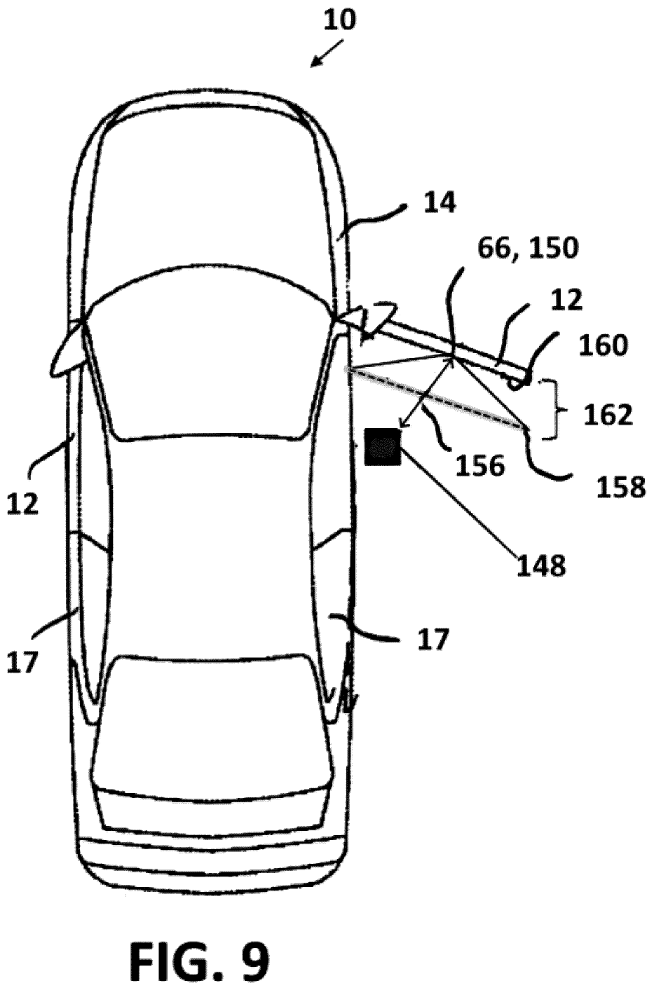

The boundary conditions for control of a closure member, such as door 12 during close and open are quite different. During a door open sequence, the door 12 is moving into an unknown environment. Objects or obstacles 148 (FIG. 9) detected by the NCOD technology (e.g., sensor 66) in that environment are separate entities from the moving door 12. A swing path of the door 12 covers a constantly increasing area (defined as a horizontal door swing zone projected onto a floor). The remaining travel to achieve predefined open position is not determined by the NCOD sensor 66; instead it is defined by the position (angle or distance from latched position) of the door 12. FIG. 7 is a side view of the vehicle 10, shown in one possible configuration as having a b-pillarless door structure e.g. no B-pillar disposed between the doors 12, 17 when they are in a closed position, illustrating the angle or position of the doors 12, 17 as the doors 12, 17 are closed. As shown, the swing doors 12, 17 can close from any angle θ, where θ is defined as the angle between the moving door 12, 17 and body 14 of the vehicle 10.

NCOD algorithms typically characterize methods to determine a) where and what the object or obstacle 148 is within the environment, b) is the object a possible risk to motion of the door 12, and c) how to react to the risk. The control boundary conditions are created to consider all unpredictable interactions a door 12 can have with their environment. For example, the objects can be static or dynamic, dynamic motion can be relatively linear (direction and velocity) or can be chaotic (direction and velocity). Objects can have large variation in shape and material composition and range in distances from the surface of the door 12. In addition, the door swing path covers a constantly increasing area (as defined as the door swing zone projected onto the floor). Therefore, the NCOD function for power door open motion can be highly complex.

With detection of the object in a known field of view (FOV) and calculating the object location to the moving surface of the door 12, radar can be used but has difficulty being applied in a door close environment due to the large amount of visible surfaces. When a door 12 is closing, all or part of the sill, seat, seatbelt, B pillar, etc. are visible. Detecting an object with high levels of noise requires high degree of measurement accuracy from radar modules. This is not always possible with current technology, or if it is possible it takes a significant amount of data/processing power. U.S. Pat. No. 10,604,984 discloses an NCOD sensor that looks for irregularities in the door distance which is used to determine if an object is detected, the entirety of which is incorporated by reference herein. However, this requires a contact to the door to register an obstacle.

Changing the control methodology from obstacle recognition to distance recognition has benefits of increasing accuracy, reducing the amount of data needed and the cost of sensors needed. Specifically with infrared time-of-flight (IR TOF) sensors, the thermal performance, power consumption and measurement accuracy can be improved over radar solutions.

In contrast to door opening operation, during door closing sequence, the door 12 is moving into a known environment. Most of the objects detected by the NCOD sensor 66 in that environment are common entities of the moving door 12. The door swing path covers a constantly decreasing area (defined as the horizontal door swing zone projected onto the floor). The remaining travel to achieved the known closed position can be determined by the NCOD sensor 66 as it is a mathematically understood relationship. With a higher degree of certainty of the environment the door 12 is moving into, the NCOD algorithm 69 (e.g., of the controller 50) can be simplified.

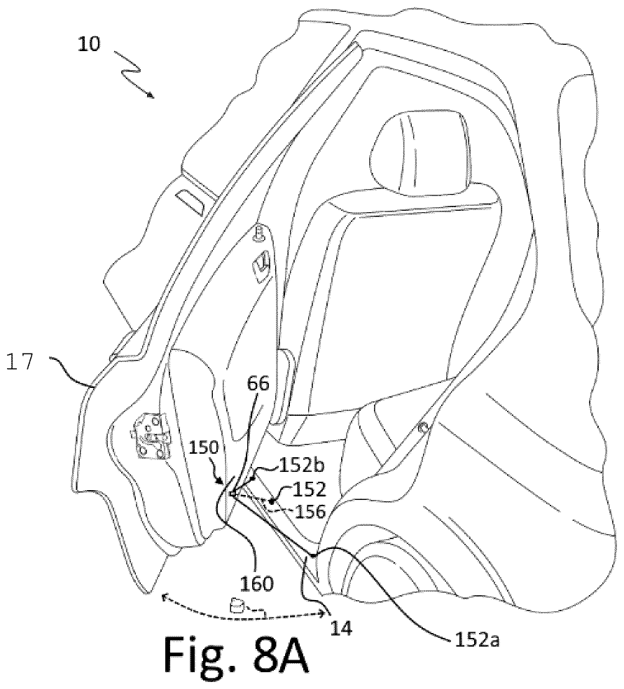

As discussed above, the power door system 21 for a door 12 of the vehicle 10 can include the actuator 22 for moving the door 12 and a sensor 66 for detecting obstacles 148. FIG. 8 is a perspective view of the door 12 of the vehicle 10 open and illustrating a sensor position 150 of the sensor 66 and a known point 152 on the body 14 of the vehicle 10. So, the sensor 66 has a field of view for detecting an obstacle 148 between the door 12 and the body 14 of the vehicle 10. As above, the power door system 21 can also include the controller 50 connected to the actuator 22 and to the sensor 66. According to aspects of the disclosure, the controller 50 is adapted to detect the obstacle 148 within the field of view that varies during movement of the door 12 (e.g., decreases as the door 12 is closed).

As above, the power door system 21 can further include at least one closure member feedback sensor 64 coupled to the controller 50 and configured to determine a position of the door 12. Referring back to FIG. 8, the sensor 66 is disposed on one of the body 14 of the vehicle 10 and the door 12 at the sensor position 150. The controller 50 is further configured to compare a mathematical distance 154 to a measured distance 156 and determine the obstacle 148 is present or not present and control the actuator 22 accordingly. The mathematical distance 154 extends between the sensor position 150 and a known point 152 on another of the body 14 of the vehicle 10 and the door 12 and is determined using the position of the door 12 determined by the at least one closure member feedback sensor 64 (i.e., according to a known or predetermined geometric relationship between the sensor position 150 and the known point 152 as the door 12 moves). The measured distance 156 extends between the sensor position 150 and one of the obstacle 148 and the known point 152 on the another of the body 14 of the vehicle 10 and the door 12, but is measured by the sensor 66 (if the sensor 66 detects the obstacle 148, the measured distance is between the sensor position 150 and the obstacle 148, but if there is no obstacle 148, the measured distance is between the sensor position 150 and the known point 152). Thus, at each position or angle ⊖ of the door 12, the mathematical distance 154 (D (ref)) can be determined mathematically defined by the sensor position 150 and the known point 152 on the body 14 (door sill shown here for illustration). The sensor 66 should be located such that the known point 152 on the body 14 is within the FOV of the sensor 66. In other words, the sensor position 150 of the sensor 66 is selected such that the known point 152 is within the field of view of the sensor 66 throughout a range of motion of the door 12 between an open position and a closed position. It should be appreciated that reversing while the sensor 66 is shown on the door 12, and the known point 152 is on the body 14, the sensor 66 could instead be located on the body 14 and the known point 152 could instead be on the door 12 (i.e., a fixed sensor 66 on the body 14 and moving target on the door 12). During a door closing operation, it is understood that the controller 50 is configured to compare a number of mathematical distances 154 to a number of measured distances 156. In another possible configuration the sensor 66 could look at multiple known points on the body 14, for example and with reference to FIG. 8A, multiple known points on the body 14 may be defined by a maximum point 152a and a minimum known point 152b, where the maximum point 152a and the minimum point 152b define distances of the FOV limits of the sensor 66, and a known point 152 on the vehicle body 142. These three known points of this illustrative example can be mathematically linked to the position or angle O of the door 12, 17.

A protect gap 158 may be defined as a plane extending in parallel to an inner surface 160 of the door 12 and spaced a predetermined protect gap distance 162 from the inner surface 160. So, the protect gap 158 is the predetermined protect gap distance 162 from and parallel to the inner surface 160 or a leading edge of the door 12 where the system 21 will not allow an obstacle 148 to enter.

FIG. 9 is a top view of the vehicle 10 showing the door 12 in an open position and illustrates an obstacle 148 and the protect gap 158. The controller 50 is further configured to receive a door close command and learn the position of the door 12 (e.g., using the at least one closure member feedback sensor 64). The controller 50 is also configured to calculate the mathematical distance 154 between the sensor position 150 and the known point 152 on another of the body 14 of the vehicle 10 and the door 12. The controller 50 measures the measured distance 156 between the sensor position 150 and one of the obstacle 148 and the known point 152 on another of the body 14 of the vehicle 10 and the door 12 using the sensor 66 and compares the measured distance 156 to the mathematical distance 154. The controller 50 turns off the sensor 66 in response to the measured distance 156 and the mathematical distance 154 being equal to a predetermined close distance. So, when the door 12 is close enough to the vehicle body 14 that the mathematical distance 154 is equal to protect gap 158, then the NCOD sensor 66 and/or the actuator 22 can disengage. This distance is called the predetermined close distance. According to an aspect, the predetermined close distance is smaller than the protect gap 158. In other words, according to an aspect, the predetermined close distance from the door 12 to the body 14 at which the mathematical distance 154 is equal to the predetermined protect gap distance 162 is less than the predetermined protect gap distance 162. The controller 50 is also configured to determine the obstacle 148 is present and stop the movement of the door 12 in response to the measured distance 156 being less than or equal to the predetermined protect gap distance 162. Thus, the controller 50 will request that the actuator 22 stop the door 12 if the measured distance 156 is less than protect gap 158. In addition, the controller 50 is configured to go to a system safe state in response to the mathematical distance 154 and the measured distance 156 not being substantially equal. So, where an obstacle 148 is present, the measured distance 156 will be smaller than the mathematical distance 154 and action may be required.

According to additional aspects of the disclosure, the controller 50 is further configured to start or continue the movement of the door 12 using the actuator 22 and update the position of the door 12 at a predetermined interval. The controller 50 calculates the mathematical distance 154 between the sensor position 150 and the known point 152 on another of the body 14 of the vehicle 10 and the door 12; The controller 50 is also configured to measure the measured distance 156 between the sensor position 150 and the known point 152 on another of the body 14 of the vehicle 10 and the door 12 using the sensor 66 at the predetermined interval. The controller 50 compares the measured distance 156 to the mathematical distance 154. Thus, upon receipt of door close command, the door system 21 will engage the actuator 22. At each position of the door 12, the controller 50 will compare measured distance 156 and the mathematical distance 154. The controller 50 turns off the sensor 66 in response to the measured distance 156 and the mathematical distance 154 being equal to the predetermined close distance. The controller 50 is additionally configured to determine the obstacle 148 is present and stop the movement of the door 12 in response to the measured distance 156 being less than or equal to the predetermined protect gap distance 162. The controller 50 goes to the system safe state in response to the mathematical distance 154 and the measured distance 156 not being substantially equal. The controller 50 returns to start or continue the movement of the door 12 using the actuator 22 in response to the mathematical distance 154 and the measured distance 156 being substantially equal. Thus, where no obstacle 148 is present, the mathematical distance 154 and the measured distance 156 should correlate and no action is required.

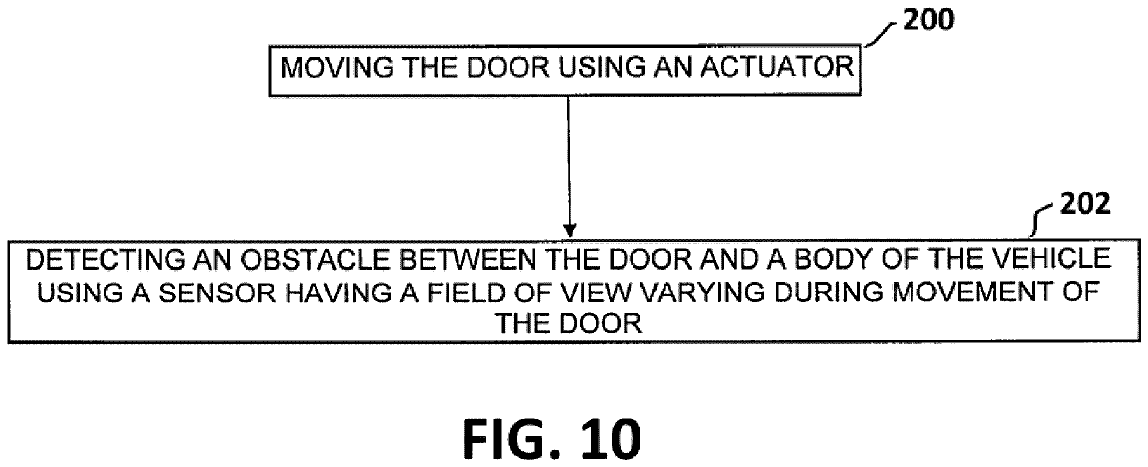

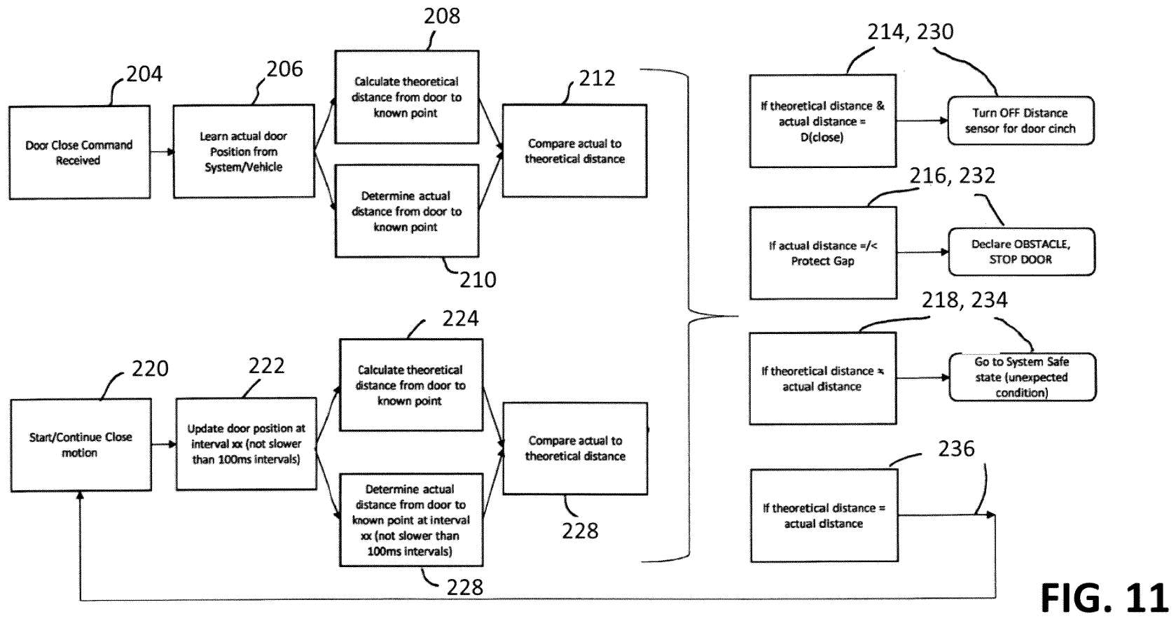

FIGS. 10 and 11 illustrate steps of a method of operating a power door system 21. Referring initially to FIG. 10, the method includes the step of 200 moving the door 12 using an actuator 22. The method also includes the step of 202 detecting an obstacle 148 between the door 12 and a body 14 of the vehicle 10 using a sensor 66 having a field of view varying during movement of the door 12.

As discussed above, the sensor 66 is disposed on one of the body 14 of the vehicle 10 and the door 12 at a sensor position 150. Thus, according to other aspects, the method further including the step of determining a position of the door 12 using at least one closure member feedback sensor 64. In addition, the method includes the step of determining a mathematical distance 154 extending between the sensor position 150 and a known point 152 on another of the body 14 of the vehicle 10 and the door 12. The method additionally includes the step of determining a measured distance 156 extending between the sensor position 150 and one of the obstacle 148 and the known point 152 on the another of the body 14 of the vehicle 10 and the door 12 using the sensor 66. The method also includes comparing the mathematical distance 154 to the measured distance 156 and determining the obstacle 148 is present or not present and controlling the actuator 22 accordingly. Again, the sensor position 150 of the sensor 66 is selected such that the known point 152 is within the field of view of the sensor 66 throughout a range of motion of the door 12 between an open position and a closed position. As discussed, the sensor 66 can be disposed on the door 12 at the sensor position 150 and the known point 152 may be disposed on the body 14 of the vehicle 10. Alternatively, the sensor 66 may instead disposed on the body 14 at the sensor position 150 and the known point 152 can be disposed on the door 12 of the vehicle 10.

As above, the power door system 21 can further include at least one closure member feedback sensor 64 configured to determine a position of the door 12. Again, the sensor 66 is disposed on one of the body 14 of the vehicle 10 and the door 12 at a sensor position 150. A protect gap 158 is defined as a plane extending in parallel to an inner surface 160 of the door 12 and spaced a predetermined protect gap distance 162 from the inner surface 160. Thus, referring specifically to FIG. 11, the method also includes the step of 204 receiving a door close command. Next, 206 learning the position of the door 12. The method proceeds with the step of 208 calculating a mathematical distance 154 between the sensor position 150 and a known point 152 on another of the body 14 of the vehicle 10 and the door 12. In addition, the method includes the step of 210 measuring a measured distance 156 between the sensor position 150 and one of the obstacle 148 and the known point 152 on another of the body 14 of the vehicle 10 and the door 12 using the sensor 66. The method continues by 212 comparing the measured distance 156 to the mathematical distance 154. The next step of the method is 214 turning off the sensor 66 in response to the measured distance 156 and the mathematical distance 154 being equal to a predetermined close distance. Next, 216 determining the obstacle 148 is present and stopping the movement of the door 12 in response to the measured distance 156 being less than or equal to the predetermined protect gap distance 162. The method also includes the step of 218 going to a system safe state in response to the mathematical distance 154 and the measured distance 156 not being substantially equal.

According to other aspects of the disclosure, the method further includes the step of 220 starting or continuing the movement of the door 12 using the actuator 22. Next, 222 updating the position of the door 12 at a predetermined interval. The method continues by 224 calculating the mathematical distance 154 between the sensor position 150 and the known point 152 on another of the body 14 of the vehicle 10 and the door 12. The next step of the method is 226 measuring the measured distance 156 between the sensor position 150 and one of the obstacle 148 and the known point 152 on another of the body 14 of the vehicle 10 and the door 12 using the sensor 66 at the predetermined interval. The method additionally includes the step of 228 comparing the measured distance 156 to the mathematical distance 154. Next, 230 turning off the sensor 66 in response to the measured distance 156 and the mathematical distance 154 being equal to the predetermined close distance. Again, according to an aspect, the predetermined close distance from the door 12 to the body 14 at which the mathematical distance 154 is equal to the predetermined protect gap distance 162 is less than the predetermined protect gap distance 162. The method proceeds with the step of 232 determining the obstacle 148 is present and stop the movement of the door 12 in response to the measured distance 156 being less than or equal to the predetermined protect gap distance 162. In addition, the method includes the step of 234 going to the system safe state in response to the mathematical distance 154 and the measured distance 156 not being substantially equal. The method also includes the step of 236 returning to starting or continuing the movement of the door 12 using the actuator 22 in response to the mathematical distance 154 and the measured distance 156 being substantially equal.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power door system for a door of a vehicle comprising:
an actuator for moving the door;
a sensor having a field of view for detecting an obstacle between the door and a body of the vehicle;
a controller connected to the actuator and to the sensor, wherein the controller is adapted to detect the obstacle within the field of view that varies during movement of the door.

2. The power door system of claim 1, further including at least one closure member feedback sensor coupled to the controller and configured to determine a position of the door and wherein the sensor is disposed on one of the body of the vehicle and the door at a sensor position and the controller is further configured to compare a mathematical distance to a measured distance and determine the obstacle is present or not present and control the actuator accordingly, the mathematical distance extending between the sensor position and a known point on another of the body of the vehicle and the door and determined using the position of the door determined by the at least one closure member feedback sensor, the measured distance extending between the sensor position and one of the obstacle and the known point on the another of the body of the vehicle and the door and measured by the sensor.

3. The power door system of claim 2, wherein the sensor position of the sensor is selected such that the known point is within the field of view of the sensor throughout a range of motion of the door between an open position and a closed position.

4. The power door system of claim 2, wherein the sensor is disposed on the door at the sensor position and the known point is disposed on the body of the vehicle.

5. The power door system of claim 2, wherein the sensor is disposed on the body at the sensor position and the known point is disposed on the door of the vehicle.

6. The power door system of claim 1, further including at least one closure member feedback sensor coupled to the controller and configured to determine a position of the door and wherein the sensor is disposed on one of the body of the vehicle and the door at a sensor position and a protect gap is defined as a plane extending in parallel to an inner surface of the door and spaced a predetermined protect gap distance from the inner surface and the controller is further configured to:
receive a door close command;
learn the position of the door;
calculate a mathematical distance between the sensor position and a known point on another of the body of the vehicle and the door;
measure a measured distance between the sensor position and the known point on another of the body of the vehicle and the door using the sensor; and
compare the measured distance to the mathematical distance.

7. The power door system of claim 6, wherein the controller is further configured to:
turn off the sensor in response to the measured distance and the mathematical distance being equal to a predetermined close distance;
determine the obstacle is present and stop movement of the door in response to the measured distance being less than or equal to the predetermined protect gap distance; and
go to a system safe state in response to the mathematical distance and the measured distance not being substantially equal.

8. The power door system of claim 7, wherein the controller is further configured to:
start or continue the movement of the door using the actuator;
update the position of the door at a predetermined interval;
calculate the mathematical distance between the sensor position and the known point on another of the body of the vehicle and the door;
measure the measured distance between the sensor position and one of the obstacle and the known point on another of the body of the vehicle and the door using the sensor at the predetermined interval; and
compare the measured distance to the mathematical distance.

9. The power door system of claim 8, wherein the controller is further configured to:
turn off the sensor in response to the measured distance and the mathematical distance being equal to the predetermined close distance;
determine the obstacle is present and stop the movement of the door in response to the measured distance being less than or equal to the predetermined protect gap distance;
go to the system safe state in response to the mathematical distance and the measured distance not being substantially equal; and
return to start or continue the movement of the door using the actuator in response to the mathematical distance and the measured distance being substantially equal.

10. The power door system of claim 6, wherein a predetermined close distance from the door to the body at which the mathematical distance is equal to the predetermined protect gap distance is less than the predetermined protect gap distance.

11. A method of operating a power door system for a door of a vehicle, the method comprising:
moving the door using an actuator; and
detecting an obstacle between the door and a body of the vehicle using a sensor having a field of view varying during movement of the door.

12. The method of claim 11, wherein the sensor is disposed on one of the body of the vehicle and the door at a sensor position, the method further including the steps of:
determining a position of the door using at least one closure member feedback sensor;
determining a mathematical distance extending between the sensor position and a known point on another of the body of the vehicle and the door;
determining a measured distance extending between the sensor position and one of the obstacle and the known point on the another of the body of the vehicle and the door using the sensor; and
comparing the mathematical distance to the measured distance and determining the obstacle is present or not present and controlling the actuator accordingly.

13. The method of claim 12, wherein the sensor position of the sensor is selected such that the known point is within the field of view of the sensor throughout a range of motion of the door between an open position and a closed position.

14. The method of claim 12, wherein the sensor is disposed on the door at the sensor position and the known point is disposed on the body of the vehicle.

15. The method of claim 12, wherein the sensor is disposed on the body at the sensor position and the known point is disposed on the door of the vehicle.

16. The method of claim 12, wherein the power door system further includes at least one closure member feedback sensor configured to determine a position of the door and wherein the sensor is disposed on one of the body of the vehicle and the door at a sensor position and a protect gap is defined as a plane extending in parallel to an inner surface of the door and spaced a predetermined protect gap distance from the inner surface and the method further comprises the steps of:
receiving a door close command;
learning the position of the door;
calculating a mathematical distance between the sensor position and a known point on another of the body of the vehicle and the door;
measuring a measured distance between the sensor position and the known point on another of the body of the vehicle and the door using the sensor; and
comparing the measured distance to the mathematical distance.

17. The method of claim 16, further including the steps of:
turning off the sensor in response to the measured distance and the mathematical distance being equal to a predetermined close distance;
determining the obstacle is present and stop the movement of the door in response to the measured distance being less than or equal to the predetermined protect gap distance; and
going to a system safe state in response to the mathematical distance and the measured distance not being substantially equal.

18. The method of claim 17, further including the steps of:
starting or continuing the movement of the door using the actuator;
updating the position of the door at a predetermined interval;
calculating the mathematical distance between the sensor position and the known point on another of the body of the vehicle and the door;
measuring the measured distance between the sensor position and one of the obstacle and the known point on another of the body of the vehicle and the door using the sensor 66 at the predetermined interval; and
comparing the measured distance to the mathematical distance.

19. The method of claim 18, further including the steps of:
turning off the sensor in response to the measured distance and the mathematical distance being equal to the predetermined close distance;
determining the obstacle is present and stop the movement of the door in response to the measured distance being less than or equal to the predetermined protect gap distance;
going to the system safe state in response to the mathematical distance and the measured distance not being substantially equal; and
returning to starting or continuing the movement of the door using the actuator in response to the mathematical distance and the measured distance being substantially equal.

20. The method of claim 16, wherein a predetermined close distance from the door to the body at which the mathematical distance is equal to the predetermined protect gap distance is less than the predetermined protect gap distance.
